(19) United States
(12) Patent Application Publication
(10) Pub. No.: US 2023/0342660 A1
(43) Pub. Date: Oct. 26, 2023

(54) SOCIAL NETWORK INITIATED LISTINGS

(71) Applicant: eBay Inc., San Jose, CA (US)

(72) Inventor: Nidhin Anisham, San Jose, CA (US)

(21) Appl. No.: 17/729,187

(22) Filed: Apr. 26, 2022

(51) Int. Cl. G06N 20/00

(52) U.S. Cl. CPC G06N 20/00

(57) ABSTRACT

A method for training and selecting machine learning models is provided. Data points associated with an item during a first time period and having a selling time associated with the item are obtained. The data points are provided to first and second machine learning models. Both the first and second machine learning models are trained with the data points. The first machine learning model predicts a first selling time using the data points. The second machine learning model predicts a second selling time using the data points. The first and second machine learning models are updatable with additional data points associated with a second time period. Each of the first selling time and the second selling time are compared with the selling time associated with the item. Based on the comparison, one of the first or second machine learning models is selected to predict selling times of future items.

### TECHNICAL FIELD

Examples of the present disclosure relate generally to machine learning models and, more particularly, but not by way of limitation, training machine learning models to determine a time to sell an item.

### BACKGROUND

Oftentimes when a seller desires to sell an item, it would be beneficial for the seller to know how long it will take for the item to sell. Currently, there are no methods or systems available that can accurately determine how long it will take to sell an item. Thus, if the seller manufactures the item, the seller may not have a good idea of when to order additional materials to create new items for sale without running the risk of having a material surplus or not having enough material to meet demand. Moreover, without knowing how long it will take to sell an item, the seller may not know how many units of the item to keep on hand. Again, the seller runs the risk of having an oversupply of the items or not having enough items to meet demand. The seller could be saddled with costs associated with having a material surplus to manufacture the item or having an excess inventory of the item. Also, the seller could miss out on potential sales by not having enough material or items to meet demand.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment suitable for selecting a machine learning model to predict a sales time, according to some examples.

FIG. 2 illustrates contents of a database of the network environment of FIG. 1, where the contents include data points associated with items that previously sold, according to some examples.

FIG. 3 shows a method for selecting a machine learning model that can be used to predict when an item will sell, according to some examples.

FIG. 4 illustrates a method of using the machine learning model selected according to FIG. 3 to predict a selling time, according to some examples.

FIG. 5 is a block diagram illustrating an architecture of software used to select a machine learning model to predict a sales time, according to some examples.

FIG. 6 shows a machine as an example computer system with instructions to cause the machine to select a machine learning model to predict a sales time, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the subject matter disclosed herein. It will be evident, however, to those skilled in the art, that examples of the subject matter disclosed herein may be practiced without these specific details. In general, well-known instruction instances, protocols, structures, and techniques are not necessarily shown in detail.

Examples relate to training and selecting a machine learning model that can be used to predict how long it will take to sell an item. In examples, the machine learning model is capable of being trained over time to improve accuracy with which the machine learning model can determine a time to sell an item. Data points associated with items that sold during a first time period are obtained along with a selling time associated with the items that sold during the first time period. The data points can include data associated with the sale of the items. The data points can include prices of the items, a time of year when the items sold, a number of photos associated with the items when the items were offered for sale, and the number of items that were sold.

In examples, some data points are more probative than other data points regarding a time to sell. These data points can more closely correlate to estimating a time to sell an item. To further illustrate, the time of year when the items sold may have a higher correlation with determining a time to sell in comparison to the number of photos associated with the items when the items were offered for sale. In an illustrative example, there may be no difference in selling time when there are five photos associated with the items when the items were offered for sale in comparison to when there are ten photos associated with the items when the items were offered for sale, while there is a difference in selling time if the items were for sale during the Holidays as opposed to being for sale in February.

The data points can be weighted based on their probative value their correlation to estimating a time to sell) and provided to a first machine learning model. Using these weighted data points, the first machine learning model predicts a first time to sell an item based on the weighted data points associated with the first item. In addition, the weighted data points are provided to a second machine learning model. Using these weighted data points, the second machine learning model predicts a second time to sell an item based on the weighted data points associated with the first item.

In examples, the first time to sell relates to an what the first machine learning model predicts how long it will take an item to sell. In examples, the first time to sell is compared to the selling time. Moreover, the second time to sell relates to an what the second machine learning model predicts how long it will take an item to sell. In examples, the second time to sell is compared to the selling time. Based on the comparison, either the first machine learning model or the second machine learning model is selected to estimate how long a second item, having attributes similar to the previously sold items, will take to sell.

In examples, the selected machine learning model is capable of being trained over time to improve the accuracy with which the machine learning model can determine a time to sell an item. For example, selling patterns for items may change over time (e.g., the number of photos associated with the items when the items were offered for sale may become more probative regarding a time to sell than the time of year when the items were sold). Data points associated with the changing selling patterns can be provided to the selected machine learning model in order to update the machine learning model such that the machine learning model can continue to accurately determine how long it will take to sell an item. Moreover, data points associated with the changing selling patterns can be provided to first and second machine learning models to redetermine which of the first and second machine learning models should be used to predict a selling time.

Moreover, selling times associated with items can change over time such that selling time predictions by a selected machine learning model can also change. In examples, additional data points associated with later sold items can be obtained where the selling times associated with later sold items differ from a previous time to sell. In particular, at an initial time, items may take an initial time to sell. Using the additional data points, it may be determined that an additional time sell is different from the initial time to sell. To further illustrate, during the first quarter of a calendar year, a mobile device sold in ten days. However, during the third quarter of the same calendar year, the same mobile device (i.e., the same model) sold in fifteen days. Here, the selected machine learning model can be trained with these additional data points (e.g., the selling time has changed to fifteen days during the third quarter of a calendar year). Therefore, in examples, a predicted selling time output by the selected machine learning model can change.

In examples, a machine learning model can be selected using a deep learning or a neural network learning method. In some examples, the machine learning model can use a corpus of: a time of year when items sold, a watchlist count, information such as feedback scores associated with a seller of the item, an amount of the item previously sold by the seller, photos associated with a listing, and/or a price for the item to create a model for estimating a time to sell. Other considerations may be included in the corpus as well without departing from the scope of the disclosure.

In another example, a machine learning model can be trained to estimate a time to sell an item using a neural network trained on a set of training data. The training data can include all the input data as will be used in a live example, as well as ground truth data (e.g., data that represents the ideal output from the model). In this example, the machine learning model, such as a neural network or other models disclosed herein, takes inputs (e.g., information such as feedback scores associated with a seller of the item, an amount of the items previously sold by, the seller, and a price for the item) where each of these inputs can be given a weight to create an output. The weight can be assigned based on the importance of the input to estimating a time to sell. For example, if the input, such as the time of year when the items were previously sold by the seller, is more probative of a predicted time to sell in comparison to a number of photos associated with a listing, the time of year can be assigned a greater weight than a number of photos in the machine learning model. An output of the machine learning model is compared to the actual time to sell, and the input used by the machine learning model can be updated until the model produces an estimated time to sell that approximates the actual time to sell.

In examples, the machine learning model can be trained over time to reflect changing selling patterns. To further illustrate, sales data accumulated at a later time can reflect that the number of photos associated with the listing has become more probative of an estimated time to sell in comparison to when the item was previously sold by the seller. The machine learning model can be updated to change the weights for the number of photos associated with the listing and when the item was previously sold by the seller such that the number of photos associated with the listing has a higher weight than when the item was previously sold by the seller in the machine learning model at a later time.

As an illustration of an example, referred to herein as the laptop illustration, a machine learning model that can be trained to estimate a time to sell a laptop computer can be selected. In the laptop illustration, data points associated with previous sales along with the selling times of laptop computers can be first accessed. These data points can include the time of year when each of the laptop computers sold and a rating associated with each seller of the sold laptop computers. Furthermore, the data points can include a price of the sold laptop computers along with an amount of the laptop computers previously sold by each seller of the sold laptop computers (e.g., one seller sold fifty of the laptop computers while another seller sold ten of the laptop computers). In the laptop illustration, the selling times are in a range of fifteen to twenty-one days.

In examples, as will be discussed in much greater detail below, an algorithm can be used to determine which data points are more probative than other data points regarding a time to sell. The algorithm can be used to determine which data points can more closely correlate to estimating a time to sell an item. In the laptop illustration, the algorithm determines that the data points relating to the time of year when each of the laptop computers sold and the rating associated with each seller of the sold laptop computers most closely correlate to estimating a time to sell a laptop computer. Furthermore, in the laptop illustration, the algorithm determines that the data points associated with a price of the sold laptop computers along with an amount of the laptop computers previously sold by each seller of the sold laptop computers are less probative of a time to sell.

Thus, in the laptop illustration, the data points relating to the time of year when each of the laptop computers sold and the rating associated with each seller of the sold laptop computers are given a first weight. Moreover, in the laptop illustration, the data points associated with the price of the sold laptop computers along with the amount of the laptop computers previously sold by each seller of the sold laptop computers are given a second weight that is less than the first weight. In examples, the weights can be numerical value, such as a whole number or a fraction, or combination of a whole number and a fraction.

In the laptop illustration, the weighted data points are provided to a first machine learning model and to a second machine learning model. Examples of the first machine learning model can include a feed-forward neural network. Examples of the second machine learning model can include XGBoost. In the laptop illustration, when the first machine learning model processes the weighted data points, the first machine learning model provides, as an output, a predicted selling time of five days. Furthermore, in the laptop illustration, when the second machine learning model processes the weighted data points, the second machine learning model provides, as an output, a predicted selling time of twenty days. The outputs of the first machine learning model and the second machine learning model are compared with the selling time of fifteen days to twenty-one days. Since the second machine learning model output an estimated selling time that is closer to the selling time of fifteen days to twenty-one days (i.e., twenty days), the second machine learning model is selected as the machine learning model for predicting how long it will take sell a laptop computer.

Thus, when a seller decides to sell a laptop computer at a later time, the seller can provide data points corresponding to the time of year when the laptop computer is for sale, a rating for the seller, a price of the laptop computer, and an amount of laptop computers previously sold by the seller. These data points are provided to the second machine learning model, which can provide a prediction of how long it will take to sell the laptop computer.

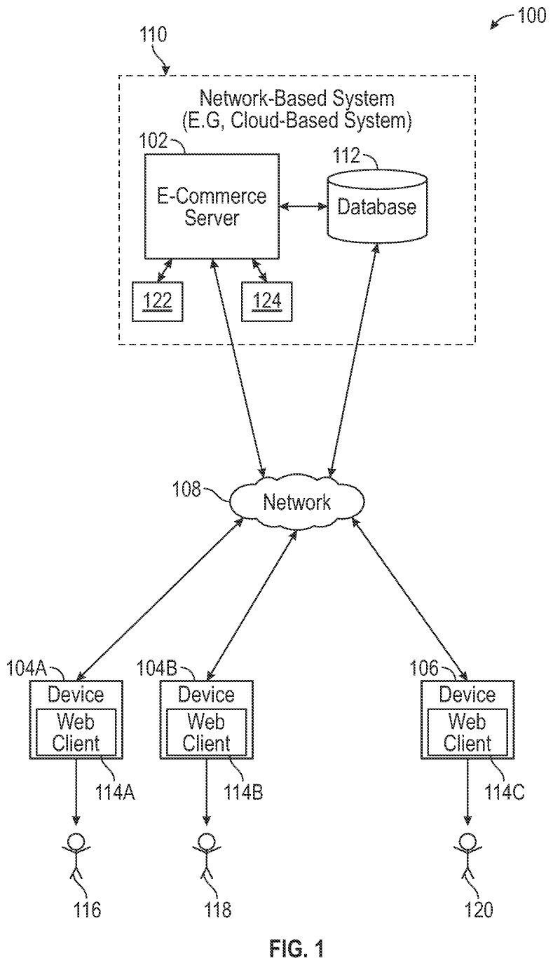

FIG. 1 is a network diagram illustrating a network environment 100 suitable for training and selecting a machine learning model to predict a sales time. The network environment 100 can include an e-commerce server 102 along with devices 104A, 104B, and 106 communicatively coupled to each other and the e-commerce network 102 via a network 108. The devices 104A and 104B can be collectively referred to as “devices 104,” or generically referred to as a “device 104.” The e-commerce server 102 can be part of a network-based system 110 that includes a cloud-based database 112. In examples, the network-based system 110 can be affiliated with an entity that provides a platform for sellers to sell items. An example of an entity can be eBay™.

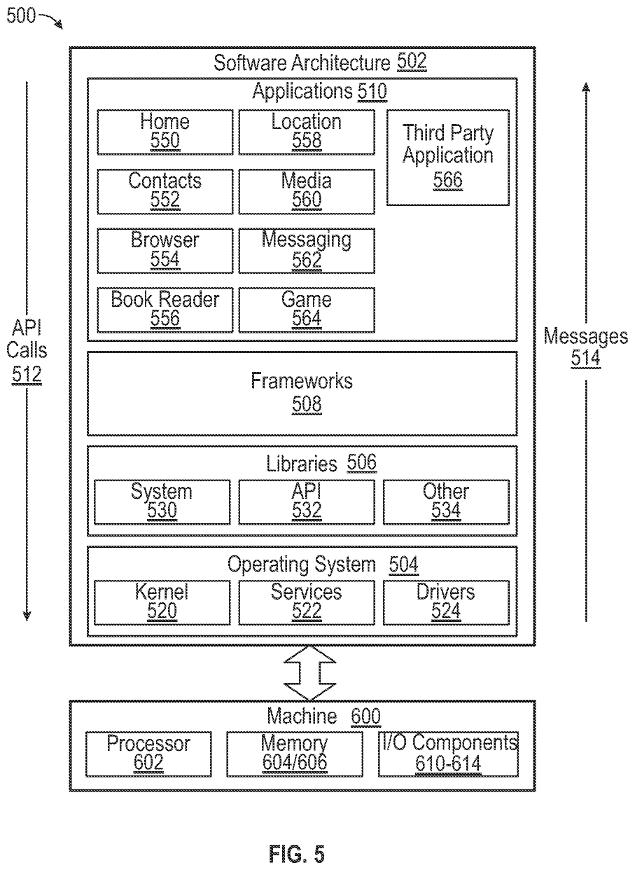

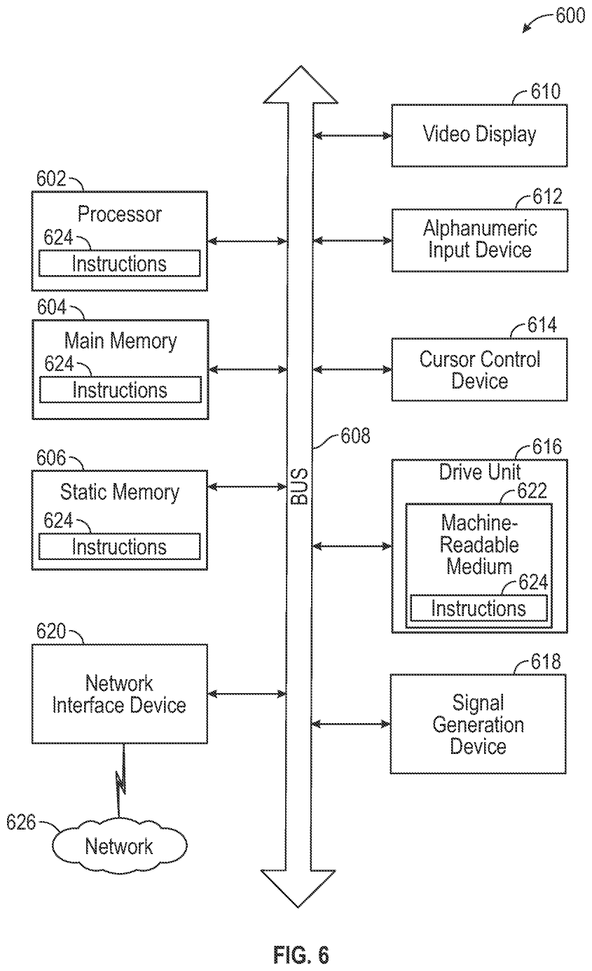

The devices 104 and 106 can interact with the e-commerce server 102 using web clients 114A-114C. The web clients 114A-114C can allow a user, such as users 116-120, to make a request and then show a result of the request. The e-commerce server 102 and the de-vices 104 and 106 can each be implemented in a computer system, in whole or in part, as described below with respect to FIGS. 5 and 6. The e-commerce server 102 provides an electronic commerce application to other machines (e.g., the devices 104 and 106) via the network 108. The electronic commerce application may provide a way for users to buy and sell items directly to each other, to buy from and sell to the electronic commerce application provider, or both.

To list an item for sale on the online marketplace, a seller can create a user account with the e-commerce server 102. The user account may include personal information (e.g., name, address, email address, phone number) and financial information (e.g., credit card information, bank account information) associated with the seller. Once the seller has created a user account, the seller can then use their user account to utilize the functionality of the e-commerce server 102, including listing an item for sale.

Also shown in FIG. 1 are the users 116-120 associated with the devices 104A, 104B, and 106. In some examples, each of the users 116-120 can be buyers of an item purchased through the network-based system 110 or a third-party vendor. The users 116-120 may be a human user (e.g., a human being), a machine user (e.g., a computer configured by a software program to interact with the devices 104 and 106 and the e-commerce server 102), or any suitable combination thereof (e.g., a human assisted by a machine or a machine supervised by a human). The users 116-120 are not part of the network environment 100 but are associated with the devices 104 and 106 and may be a user of the devices 104 and 106 (e.g., an owner of the devices 104 and 106). For example, the devices 104 and 106 may be a sensor, a desktop computer, a vehicle computer, a tablet computer, a navigational device, a portable media device, or a smart phone belonging to ones of the users 116-120. Moreover, the users 116-120 can be a buyer and/or a seller, where each of the buyer and the seller can be associated with any of the devices 104 and 106. Furthermore, the users 116-120 can be associated with a user account accessible by the electronic commerce application provided by the e-commerce server 102 via which the users 116-120 interact with the e-commerce server 102.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 5 and 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 108 may be any network that enables communication between or among machines, databases, and devices (e.g., the e-commerce server 102 and the devices 104 and 106). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

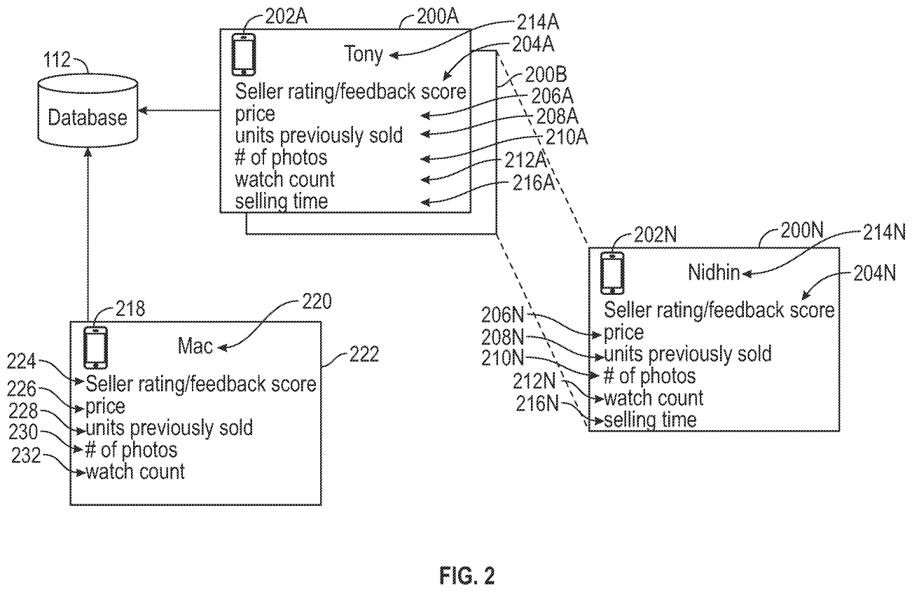

Examples of the cloud-based database 112 can include the Simple Storage Service offered by Amazon Web Services™ along with a SwiftStack™ object storage system. The cloud-based database 112 can store information relating to items previously sold by sellers using an entity that provides a platform for sellers to sell items. For example, making reference to FIG. 2, the cloud-based database 112 can store sold information 200A-200N relating to mobile devices 202A-202N. It should be noted that while FIG. 2 illustrates the cloud-based database 112 storing three iterations of sold information 200A-200N, examples envision the cloud-based database 112 holding any number of sold information, such as hundreds, thousands, hundreds of thousands, millions, and the like. The sold information 200A can relate to a mobile device 202A that includes data points 204A-212A associated with sale of the mobile device 202A. The sold information 200N can relate to a mobile device 202N that includes data points 206N-212N associated with the sale of the mobile device 202N. While only two iterations of the datapoints 204A-212A and 204N-212N are illustrated, examples envision the cloud-based database 112 holding any number of sold information having any number of data points, such as hundreds, thousands, hundreds of thousands, millions, and the like.

Furthermore, throughout this disclosure, reference may be made to datapoints 204A-204N, 206A-206N, 208A-208N, 210A-210N, and 212A-212N. Examples envision that when reference is made to datapoints 204A-204N, 206A-206N, 208A-208N, 210A-210N, and 212A-212N, this can refer to any number of data points, such as hundreds, thousands, hundreds of thousands, millions, and the like. To further illustrate, reference to data points 204A-204N can refer to hundreds, thousands, hundreds of thousands, millions, and the like, of data points 204A-204N.

Regarding the data points, the data point 204A can be a seller rating feedback score 204A that relates to a seller Tony 214A of the mobile device 202A. It should be noted that, for purposes of this disclosure, the element having reference numeral 204A can be interchangeably referred to as data point 204A and seller rating/feedback score 204A. The data point 204N can be a seller rating/feedback score 204N that relates to a seller Nidhin 214N of the mobile device 202N. It should be noted that, for purposes of this disclosure, the element having reference numeral 204N can be interchangeably referred to as data point 204N and seller rating/feedback score 204N.

The datapoint 206A can be a price 206A that the mobile device 202A sold for. It should be noted that, for purposes of this disclosure, the element having reference numeral 206A can be interchangeably referred to as data point 206A and price 206A. The datapoint 206N can be a price 206N that the mobile device 202N sold for. For purposes of this disclosure, the element having reference numeral 206N can be interchangeably referred to as data point 206N and price 206N.

The data point 208A can be a datapoint that relates to units previously sold 208A of the mobile device 202A by the seller Tony 214A. For purposes of this disclosure, the element having reference numeral 208A can be interchangeably referred to as data point 208A and units previously sold 208A. The data point 208N can be a datapoint that relates to units previously sold 208N of the mobile device 202N by the seller Nidhin 214N. For purposes of this disclosure, the element having reference numeral 208N can be interchangeably referred to as data point 208N and units previously sold 208N.

The datapoint 210A can be a data point that relates to a number of photos 210A that accompanied the listing for the mobile device 202A when the mobile device 202A was listed for sale. For purposes of this disclosure, the element having reference numeral 210A can be interchangeably referred to as data point 210A and number of photos 210A. The data point 210N can be a data point that relates to a number of photos 210N that accompanied the listing for the mobile device 202N when the mobile device 202N was listed for sale. For purposes of this disclosure, the element having reference numeral 210N can be interchangeably referred to as data point 210N and number of photos 210N.

The data point 212A can be a data point that corresponds to a watch count 212A for the listing that was used when the mobile 202A was sold. In examples, the watch count 212A can refer to a number of users that are watching an auction associated with the mobile device 202A. Similar to other data points 204A-210A, for purposes of this disclosure, the element having reference numeral 212A can be interchangeably referred to as data point 212A and watch count 212A. The data point 212N can be a data point that corresponds to a watch count 212N for the listing that was used when the mobile device 202N was sold. In examples, the watch count 212N can refer to a number of users that are watching an auction associated with the mobile device 202N. For purposes of this disclosure, the element having reference numeral 212N can be interchangeably referred to as data point 212N and watch count 212N.

In addition, the sold information 200A can include a selling time 216A and the sold information 200N can include a selling time 216N. In examples, the selling time 216A can be the time it took for the mobile device 202A to sell. Furthermore, the selling time 216N can relate to the time it took for the mobile device 202N to sell.

Returning attention back to FIG. 1, the e-commerce server 102 can also be associated with a first machine learning model 122 and a second machine learning model 124. The first machine learning model 122 and the second machine learning model 124 can employ any type of machine learning model. Examples of machine learning models that can be used can include Classification And Regression Training, gradient boosted machines, glmnet, randomForest, SciPy, XGBoost, and various neural networks, such as a Feed-Forward neural network, a radial basis function neural network, a multilayer perceptron neural network, a convolutional neural network, a recurrent neural network, and a modular neural network.

In accordance with examples, each of the first machine learning model 122 and the second machine learning model 124 can be trained to predict an estimated selling time for an item. As will be discussed further below, using historical data points, such as the data points 204A-212A and 204N-212N, and selling times, such as the selling times 216A and 216N, an accuracy for predicting selling times of items of the first machine learning model 122 and an accuracy for predicting selling times of items of the second machine learning model 124 can be determined. Based on the accuracy, either the first machine learning model 122 or the second machine learning model 124 can be selected for predicting selling times of items.

As will be discussed further below, during training of the first machine learning model 122, data points for previously sold items, which can be weighted, are provided to the machine learning model 122 along with the selling times of the previously sold items. Using supervised learning tasks, a knowledge base is built. Using neural network techniques, the first machine learning model 122 can tune itself to predict the selling times of the previously sold items using the weighted data points during training. The first machine learning model 122 can then be used to predict selling times of items when data points that correlate to the weighted data points in the first machine learning model 122 are provided to the first machine learning model 122. The first machine learning model 122 can be continually updated with new training data over time such that the first machine learning model 122 can change over time with new training data, different training data, or a combination of the two, that is provided to the first machine learning model 122 over time. Moreover, the training data can include the data points disclosed herein, the selling times disclosed herein, and a combination of the data points and the selling times disclosed herein.

In examples where the second machine learning model 124 uses XGBoost, the second machine learning model 124 can employ regression and classification procedures to develop a model for predicting selling times of items. During training of the second machine learning model 124, the data points for previously sold items, which can be weighted, are provided to the second machine learning model 124 along with the selling times of the previously sold items. Using regression and classification procedures, the second machine learning model 124 can tune itself to predict the selling time of the previously sold items using the weighted data points. The second machine learning model 124 can then be used to predict selling times of items when data points that correlate to the weighted data points in the second machine learning model 124 are provided to the second machine learning model 124. The second machine learning model 124 can be continually updated with new training data over time such that the second machine learning model 124 can change over time with new training data, different training data, or a combination of the two, that is provided to the second machine learning model 124 over time. In addition, the training data can include the data points disclosed herein, the selling times disclosed herein, or a combination of the data points and the selling times disclosed herein.

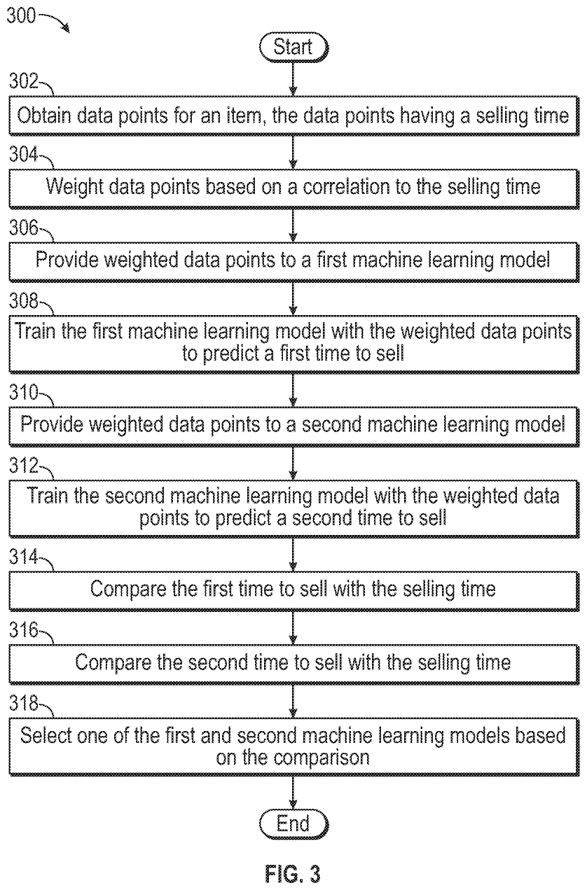

As noted above, examples relate to selecting a machine learning model that can be used to predict how long it will take to sell an item. Here, the datapoints 204A-212A and 204N-212N along with the selling times 216A and 216N can be used to select a machine learning model that can be used to predict when an item, such as a mobile device 218 (FIG. 2), will sell. Now making reference to FIG. 3, a method 300 for selecting a machine learning model that can be used to predict when an item will sell is shown.

During an operation 302, the method 300 obtains data points for sold items, where the data points can include a selling time associated with selling the sold items. The data points can include data associated with the sale of the sold items. For example, the data points can include a price of the sold items, a number of photos associated with the sold items when the sold items were offered for sale, and the number of sold items that were sold. The data points can also include data associated with the sellers of the sold items. In addition, the data points can include a seller rating of the sellers and a number of units of the sold item the seller previously sold. The data points can also include a watch count that was associated with the sold items. It should be noted the data points are not restricted to the examples disclosed herein. Thus, the data points can include any type of data associated with the sale of the sold items and the sold items themselves.

After the data points are obtained during the operation 302, the method 300 weights the data points during an operation 304. In some examples, the data points can be weighted based on their probative value (i.e., their correlation to estimating a time to sell). In an example, an algorithm can be used to determine which data points are more probative than other data points regarding a time to sell. In particular, the algorithm can be used to determine which data points can more closely correlate to estimating a time to sell an item. An example of an algorithm that can be used can include the following Equation:

$$r = \frac{\sum ( x - \overline{x} ) ( y - \overline{y} )}{\sqrt{\sum {( x - \overline{x} )}^{2} \sum {( y - \overline{y} )}^{2}}} \qquad ( 1 )$$

In Equation (1) above, r is a correlation coefficient, which relates the data point to the probability that the feature is probative of the time the item will sell. x can relate to the actual data point, such as the number of photos that accompany the listing, and the like. x̅ can relate to the mean of the data point. y can relate to the number of days it took the item to sell. y̅ can relate to the mean of the numbers of days it took the item to sell.

Using the algorithm, such as the Equation (1), a determination can be made regarding which data points more closely correlate to estimating a time to sell. The value for the correlation coefficient r can be used to determine if the data point is probative of the time the item will sell and thus more closely correlates to estimating the time to sell. In examples, the value of the correlation coefficient r can be compared to a range and based on the comparison, the correlation of the data to estimating a time to sell can be determined. To further illustrate, in some examples, a value for the correlation coefficient r can be in a range between −1 and +1. In examples, when the value falls closer to either −1 or +1, the data point used to calculate the correlation coefficient r will be more probative of the time the item will sell. Alternatively, when values fall closer to 0, the data point used to calculate the correlation coefficient r will be less probative of the time the item will sell. Thus, in examples, when a data point has a correlation coefficient r of either −0.7 or +0.7, this data point is more probative of the time the item will sell in comparison to a data point that has a correlation coefficient r of either −0.1 or +0.1.

Moreover, based on which data points more closely correlate to estimating a time to sell an item, a weight can be assigned to the data points obtained. For example, if the data point of a watch count is more probative regarding a time to sell (e.g., has a correlation coefficient r of either −0.8 or +0.8, the data point of a watch count more closely correlates to estimating a time to sell an item), this data point can be assigned a first weight. Similarly, if the data point number of photos is less probative regarding a time to sell (e.g., has a correlation coefficient r of either −0.2 or +0.2), this data point can be assigned a second weight that is less than the first weight.

In examples, the weight can be a weighting factor applied to the data point based on whether or not the data point is more probative or less probative of a time to sell. In examples, for data points that are more probative regarding a time to sell (i.e., have more of a correlation to estimating the time to sell), the weighting factor can be a numerical value in a range between 1.0 and 10.0 that can be assigned to the data points. For data points that are less probative regarding a time to sell, (e.g., have less of a correlation to estimating the time to sell), the weighting factor can be in a range between 0.1 and 0.9 in order to deemphasize this particular data point when predicting a time to sell an item. It should be noted that while ranges between 1.0 and 10.0 and 0.1 and 0.9 are listed for the weight, examples envision any range.

In some examples, a machine learning model, such as the first machine learning model 122 and the second machine learning model 124, can perform the operation 304. In this example, the first machine learning model 122 and the second machine learning model 124 can apply the Equation (1) to ascertain which data points are more probative regarding a time to sell as detailed above. Furthermore, in some examples, the first machine learning model 122 and the second machine learning model 124 can apply weights to the data points as discussed above. In further examples, the e-commerce server 102 can perform the operation 304.

As an illustration of the method 300, referred to herein as the “machine learning model illustration,” during the operation 302, the e-commerce server 102 accesses the database 112 and obtains the datapoints 204A-2112A and 204N-2112N along with the selling times 216A-216N. In the machine learning model illustration, the selling times 216A-216N are ten days for the mobile devices 202A-202N. The method 300 then weights each of the datapoints 204A-212A and 206A-212A during the operation 304 using the Equation (1) shown above. In the machine learning model illustration, the e-commerce server 102 determines that the units previously sold 208A-208N by sellers, such as the seller Tony 214A and the seller Nidhin 214N, have a high correlation to predicting the selling times 216A-216N using the Equation (1). Therefore, during the operation 304, the e-commerce server 102 applies a weighting factor, which can correspond to a weight, of 1.6 to the datapoints 208A-208N.

Additionally, the e-commerce server 102 determines that the seller rating/feedback scores 204A-204N associated with sellers, such as the seller Tony 214A and the seller Nidhin 214N, have a high correlation to predicting the selling times 216A-216N using the Equation (1). However, in the machine learning model illustration, the seller rating/feedback score 204A-204N does not have as high a correlation to predicting selling times using the Equation (1). Thus, during the operation 204, the e-commerce server 102 will apply a weighting factor, which can correspond to a weight, of 1.3 to the datapoints 204A-204N.

Furthermore, during the operation 304, using the Equation (1), the e-commerce server 102 determines that the number of photos 210A-210N and the watch count 212A-212N each have a low correlation to determining the selling times 216A-216N. In the machine learning model illustration, the number of photos 210A-210N has a lower correlation to predicting the selling times 216A-216N in comparison to the watch count 212A-212N. As such, during the operation 304, the e-commerce server 102 will apply a weighting factor, which can correspond to a weight, of 0.6 to the datapoints 210A-210N. Additionally, during the operation 304, the e-commerce server 102 will apply a weighting factor, which can correspond to a weight, of 0.9 to the datapoints 212A-212N.

After the operation 304, the method 300 performs an operation 306, where the method 300 provides the weighted data points to a first machine learning model. Using the weighted data points, the method 300 trains the first machine learning model during an operation 308. In the operation 308, the first machine learning model is trained with the weighted data points such that the first machine learning model can predict a first selling time for the items associated with the weighted data points.

Returning to the machine learning model illustration and making reference to FIG. 1, during the operation 306, the e-commerce server 102 provides the weighted data points corresponding to the units previously sold 208A-208N and the seller rating/feedback scores 204A-204N to the first machine learning model 122 associated with the e-commerce server 102. Moreover, the e-commerce server 102 provides the weighted data points corresponding to the number of photos 210A-210N and the watch count 212A-212N to the first machine learning model 122 during the operation 306.

In the machine learning model illustration, the first machine learning model 122 is a neural network. Thus, during the operation 308, using supervised learning, the first machine learning model 122 is trained to determine the selling time using the weighted data points of the previously sold items along with the selling times of the previously sold items. In particular, the first machine learning model 122 is trained with the weighted data points that correspond to the units previously sold 208A-208N, the seller rating/feedback scores 204A-204N, the number of photos 210A-210N, and the watch count 212A-212N. Furthermore, using these data points, in the machine learning model illustration, the first machine learning model 122 predicts a first selling time of fifteen days.

After the operation 308, the method 300 performs an operation 310, where the method 300 provides the weighted data points to a second machine learning model. Using the weighted data points, the method 300 trains the second machine learning model during an operation 312. In the operation 312, the second machine learning model is trained with the weighted data points such that the second machine learning model can predict a second selling time for the items associated with the weighted data points. It should be pointed out that while the operations 310 and 312 are described as occurring after the operations 306 and 308, in examples, the method 300 can perform the operations 310 and 312 simultaneously with the operations 306 and 308 such that multiple machine learning models are simultaneously trained and simultaneously predict selling times.

Returning to the machine learning model illustration and FIG. 1, during the operation 310, the e-commerce server 102 provides the weighted data points corresponding to the units previously sold 208A-208N and the seller rating/feedback scores 204A-204N to the second machine learning model 124 associated with the e-commerce server 102. The e-commerce server 102 also provides the weighted data points corresponding to the number of photos 210A-210N and the watch count 212A-212N to the second machine learning model 124 during the operation 310.

In the machine learning model illustration, the second machine learning model 124 uses XGBoost machine learning techniques. Accordingly, during the operation 312, using regression and classification procedures to develop a model for predicting selling times of items, the second machine learning model 124 trains to determine the selling time using the weighted data points of the previously sold items along with the selling times of the previously sold items. In particular, the second machine learning model 124 is trained with the weighted data points that correspond to the units previously sold 208A-208N, the seller rating/feedback scores 204A-204N, the number of photos 210A-210N, and the watch count 212A-212N. In the machine learning model illustration, using these data points, the second machine learning model 124 predicts a selling time of twelve days.

Once the operation 312 is complete, the method 300 performs an operation 314 where the first selling time predicted during the operation 308 is compared with the selling time. Moreover, the method 300 performs an operation 316 where the second selling time predicted during the operation 312 is compared with the selling time. It should be pointed out that while the operation 316 is described as occurring after the operation 314, in examples, the method 300 can perform the operations 314 and 316 substantially simultaneously.

In the machine learning model illustration, during the operation 314, the e-commerce server 102 can compare the first selling time predicted by the first machine learning model 122, which was fifteen days, with the selling time, which, in the machine learning model illustration, was ten days. Furthermore, during the operation 316, the e-commerce server 102 can compare the second selling time predicted by the second machine learning model 124, which the second machine learning model 124 predicted to be twelve days, with the selling time.

After the comparison, the method 300 selects a machine learning model during an operation 318. In examples, the method 300 can select a machine learning model that predicts a selling time within a threshold. In examples, the threshold can be in a range between one percent and twenty percent of the actual selling time. To further illustrate, if the actual selling time is twenty days and the threshold is in a range between one percent and twenty percent of the actual selling time, the machine learning model that predicts a selling time between sixteen days and twenty-fours days can be selected. In addition, if the threshold is between one and twenty percent and multiple machine learning models predict a selling time in this range, in examples, the method 300 can select the machine learning model that predicts a selling time closest to the actual selling time. Thus, if a first machine learning model makes a prediction within ten percent and a second machine learning model makes a prediction within fifteen percent, examples can select the first machine learning model since the first machine learning model was within ten percent.

In the machine learning model illustration, the actual selling time was ten days. Additionally, in the machine learning model illustration, the threshold is in a range between one percent and twenty percent of the actual selling time. Therefore, in the machine learning model illustration, a predicted selling time in a range between eight days and twelve days would be within the threshold. During the operation 318, the e-commerce server 102 determines that the selling time of fifteen days predicted by the first machine learning model 122 exceeds the threshold. Moreover, during the operation 318, the e-commerce server 102 determines that the selling time of ten days predicted by the second machine learning model 124 is within the threshold. Thus, during the operation 318, in the machine learning model illustration, the second machine learning model 124 is selected. Upon completion of the operation 318, the method 300 is complete.

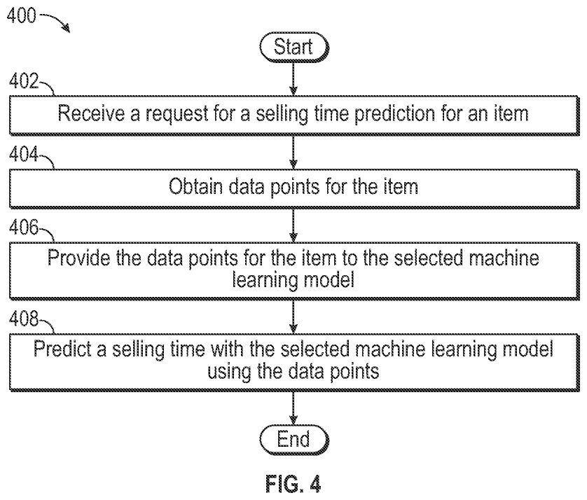

Now making reference to FIG. 4 and a method 400, an example of using the machine learning model selected with method 300 to predict a selling time is shown in accordance with examples. In an operation 400, a request is received for a selling time prediction of an item. To further illustrate the method 400, making reference to FIGS. 1 and 2 and described herein as the “mobile device illustration,” a seller Mac 220 decides to sell the mobile device 218. Moreover, the seller Mac 220 would like an estimate regarding how long it will take to sell the mobile device 218. As such, during the operation 402, the seller Mac 220 provides a request to the e-commerce server 102 via the web client 1140 for a selling time prediction of the mobile device 218.

Returning attention to FIG. 4, in response to receiving the request for the selling time prediction, the method 400 obtains data points for the item during an operation 404. In the mobile device illustration, when creating the listing to sell the mobile device 218, the seller Mac 220 provides device information 222, which can include data points 224-230, as shown with reference to FIG. 2. In the mobile device illustration, the seller Mac 220 provides the device information via the web client 1140. The device information 222 can be stored at the database 112. The data point 224 can be a seller rating/feedback score 224 that relates to the seller Mac 220. For purposes of this disclosure, the element having reference numeral 224 can be interchangeably referred to as data point 224 and seller rating/feedback score 224. The datapoint 226 can be a price 226 of the mobile device 218 that the seller Mac 220 is selling. It should be noted that, for purposes of this disclosure, the element having reference numeral 226 can be interchangeably referred to as data point 226 and price 226.

The datapoint 228 can be a datapoint that relates to units previously sold 228 of the mobile device 218 by the seller Mac 220. It should be noted that, for purposes of this disclosure, the element having reference numeral 228 can be interchangeably referred to as data point 228 and units previously sold 228. The datapoint 230 can be a datapoint that relates to a number of photos 230 that accompanies the listing for the mobile device 218 that will be sold. For purposes of this disclosure, the element having reference numeral 230 can be interchangeably referred to as data point 230 and number of photos 230. The datapoint 232 can be a datapoint that corresponds to a watch count 232 for the listing that is being used to sell the mobile device 218. In examples, the watch count 232 can refer to a number of users that are watching an auction associated with the mobile device 218. For purposes of this disclosure, the element having reference numeral 232 can be interchangeably referred to as data point 232 and a watch count 232. In the mobile device illustration, during the operation 404, the method 400 obtains the data points 224-232 from the database 112.

After obtaining the data points for the item during the operation 404, the method 400 performs an operation 406, where the data points are provided to a selected machine learning model. With the data points provided in the operation 406, the method 400 predicts a selling time using the selected machine learning model during an operation 408. During the operation 408, the selected machine learning model can weigh the data points received during the operation 406 and predict a time to sell using the weighted data points as detailed above with reference to FIG. 3 and the method 300.

Making reference again to the mobile device illustration, the second machine learning model 124 is the selected machine learning model. Thus, during the operation 406, the e-commerce server 102 provides the data points 224-232 to the second machine learning model 124. In the mobile device illustration, during training, the second machine learning model 124 was trained according to the method 300 and, in particular, the operation 312. Specifically, the second machine learning model 124 was trained to weight the data points as detailed with respect to the method 300. Thus, during the operation 408, the second machine learning model 124 applies a weighting factor of 1.6 to the units previously sold 128 by the seller Mac 220. In addition, the second machine learning model 124 applies a weighting factor of 1.3 to the seller rating/feedback score 224 associated with the seller Mac 220. Moreover, the datapoints 230 and 232 have a low correlation to the selling time. Thus, during the operation 408, the second machine learning model applies a weight of 0.6 to the number of photos 230 and a weight of 0.9 to the watch count 232.

Using these weights, the second machine learning model 124 predicts that a selling time for the mobile device 218 will be about thirteen days. In an example, the predicted selling time is provided to the seller Mac 220 and the method 400 is complete.

FIG. 5 is a block diagram 500 illustrating a software architecture 502, which may be installed on any one or more of the devices described above. FIG. 6 is merely a non-limiting example of a software architecture, and it will be appreciated that many other architectures may be implemented to facilitate the functionality described herein. The software architecture 502 may be implemented by hardware such as a machine 600 of FIG. 6 that includes a processor 602, memory 604 and 606, and I/O components 610-614. In this example, the software architecture 502 may be conceptualized as a stack of layers where each layer may provide a particular functionality. For example, the software architecture 502 includes layers such as an operating system 504, libraries 506, frameworks 508, and applications 510. Operationally, the applications 510 invoke application programming interface (API) calls 512 through the software stack and receive messages 514 in response to the API calls 512, according to some implementations.

In various implementations, the operating system 504 manages hardware resources and provides common services. The operating system 504 includes, for example, a kernel 520, services 522, and drivers 524. The kernel 520 acts as an abstraction layer between the hardware and the other software layers in some implementations. For example, the kernel 520 provides memory management, processor management (e.g., scheduling), component management, networking, and security settings, among other functionality. The services 522 may provide other common services for the other software layers. The drivers 524 may be responsible for controlling or interfacing with the underlying hardware. For instance, the drivers 524 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 506 provide a low-level common infrastructure that may be utilized by the applications 510. The libraries 506 may include system libraries 530 (e.g., C standard library) that may provide functions such as memory allocation functions, string manipulation functions, mathematic functions, and the like. In addition, the libraries 506 may include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 may also include a wide variety of other libraries 534 to provide many other APIs to the applications 510.

The frameworks 508 provide a high-level common infrastructure that may be utilized by the applications 510, according to some implementations. For example, the frameworks 508 provide various graphic user interface (GUI) functions, high-level resource management, high-level location services, and so forth. The frameworks 508 may provide a broad spectrum of other APIs that may be utilized by the applications 510, some of which may be specific to a particular operating system or platform.

In an example, the applications 510 include a home application 550, a contacts application 552, a browser application 554, a book reader application 556, a location application 558, a media application 560, a messaging application 562, a game application 564, and a broad assortment of other applications such as a third-party application 566. According to some examples, the applications 510 are programs that execute functions defined in the programs. Various programming languages may be employed to create one or more of the applications 510, structured in a variety of manners, such as object-orientated programming languages (e.g., Objective-C, Java, or C++) or procedural programming languages (e.g., C or assembly language). In a specific example, the third-party application 566 (e.g., an application developed using the Android™ or iOS™ software development kit (SDK) by an entity other than the vendor of the particular platform) may be mobile software running on a mobile operating system such as iOS™, Android™ Windows® Phone, or other mobile operating systems. In this example, the third-party application 566 may invoke the API calls 512 provided by the mobile operating system (e.g., the operating system 504) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically, constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 108 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 6 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device (cursor control device) 614 (e.g., a mouse), a disk drive unit 616, a signal generation device 618 (e.g., a speaker) and a network interface device 620.

The drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. Instructions 624 may also reside within the static memory 606.

While the machine-readable medium 622 is shown in an example to be a single medium, the term “machine-readable medium” may include a single medium or multiple media (e.g., a centralized or distributed database, and/or associated caches and servers) that store the one or more instructions or data instructions 624. The term “machine-readable medium” shall also be taken to include any tangible medium that is capable of storing, encoding or carrying instructions 624 for execution by the machine and that cause the machine to perform any one or more of the methodologies of the present invention, or that is capable of storing, encoding or carrying data structures utilized by or associated with such instructions 624. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 624 for execution by the machine, and includes digital or analog communications signals or other intangible media to facilitate communication of such software.

Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

1. A method comprising:
obtaining data points associated with a first item during a first time period, the data points associated with the first item including a selling time associated with the first item;
providing the data points associated with the first item to a first machine learning model;
training the first machine learning model with the data points associated with the first item, the first machine learning model predicting a first time to sell an item based on the data points associated with the first item, the first machine learning model being updatable with additional data points associated with a second time period;
providing the data points associated with the first item to a second machine learning model;
training the second machine learning model with the data points associated with the first item, the second machine learning model predicting a second time to sell an item based on the data points associated with the first item, the second machine learning model being updatable with the additional data points associated with the second time period;
comparing the first time to sell with the selling time;
comparing the second time to sell with the selling time; and
selecting the first machine learning model or the second machine learning model based on the comparing the first time to sell with the selling time and the comparing the second time to sell with the selling time.

2. The method of claim 1, further comprising:
obtaining data points associated with a second item;
providing the data points associated with the second item to the selected trained machine learning model; and
determining a time estimate associated with selling the second item with the selected trained machine learning model, the time estimate being based on the data points associated with the second item.

3. The method of claim 2, further comprising:
receiving an identification of the second item; and
retrieving the data points associated with the second item from a database based on the second item identification.

4. The method of claim 2, wherein the data points associated with the second item further comprise a feedback score associated with a seller of the second item and one or more of a price of the second item, a number of images associated with a listing of the second item, or a quantity of the second item.

5. The method of claim 1, the method further comprising:
obtaining data points associated with a third item during at least a portion of the second time period, the data points associated with the third item including a selling time associated with the third item where the selling time associated with the third item is different from the selling time associated with the first item; and
training the selected machine learning model with the data points associated with the third item, where further time estimates determined by the selected machine learning model differ from the time estimate associated with selling the second item based on the data points associated with the third item.

6. The method of claim 1, wherein the data points associated with the first item further comprise a feedback score associated with a seller of the first item and one or more of a price of the first item, a number of images associated with a listing of the first item, or a quantity of the first item.

7. The method of claim 1, further comprising assigning different weights to each of the data points associated with the first item, the weighted attributes being used to train each of the first machine learning model and the second machine learning model to predict the time estimate associated with selling the second item.

8. A non-transitory machine-readable medium having instructions embodied thereon, the instructions executable by a processor of a machine to perform operations comprising:
obtaining data points associated with a first item during a first time period, the data points associated with the first item including a selling time associated with the first item;
providing the data points associated with the first item to a first machine learning model;
training the first machine learning model with the data points associated with the first item, the first machine learning model predicting a first time to sell an item based on the data points associated with the first item, the first machine learning model being updatable with additional data points associated with a second time period;
providing the data points associated with the first item to a second machine learning model;
training the second machine learning model with the data points associated with the first item, the second machine learning model predicting a second time to sell an item based on the data points associated with the first item, the second machine learning model being updatable with the additional data points associated with the second time period;
comparing the first time to sell with the selling time;
comparing the second time to sell with the selling time; and
selecting the first machine learning model or the second machine learning model based on the comparing the first time to sell with the selling time and the comparing the second time to sell with the selling time.

9. The non-transitory machine-readable medium of claim 8, the operations further comprising:
obtaining data points associated with a second item;
providing the data points associated with the second item to the selected trained machine learning model; and
determining a time estimate associated with selling the second item with the selected trained machine learning model, the time estimate being based on the data points associated with the second item.

10. The non-transitory machine-readable medium of claim 9, wherein the data points associated with the second item further comprise a feedback score associated with a seller of the second item and one or more of a price of the second item, a number of images associated with a listing of the second item, and a quantity of the second item.

11. The non-transitory machine-readable medium of claim 8, the operations further comprising:
obtaining data points associated with a third item during at least a portion of the second time period, the data points associated with the third item including a selling time associated with the third item where the selling time associated with the third item is different from the selling time associated with the first item; and
training the selected machine learning model with the data points associated with the third item, where further time estimates determined by the selected trained machine learning model differ from the time estimate associated with selling the second item based on the data points associated with the third item.

12. The non-transitory machine-readable medium of claim 8, wherein the data points associated with the first item further comprise a feedback score associated with a seller of the first item and one or more of a price of the first item, a number of images associated with a listing of the first item, and a quantity of the first item.

13. The non-transitory machine-readable medium of claim 8, the operations further comprising assigning different weights to each of the data points associated with the first item, the weighted attributes being used to train each of the first machine learning model and the second machine learning model to predict the time estimate associated with selling the second item.

14. A device, comprising:
a processor; and
memory including instructions that, when executed by the processor, cause the device to perform operations including:
obtaining data points associated with a first item during a first time period, the data points associated with the first item including a selling time associated with the first item;
providing the data points associated with the first item to a first machine learning model;
training the first machine learning model with the data points associated with the first item, the first machine learning model predicting a first time to sell an item based on the data points associated with the first item, the first machine learning model being updatable with additional data points associated with a second time period;
providing the data points associated with the first item to a second machine learning model;
training the second machine learning model with the data points associated with the first item, the second machine learning model predicting a second time to sell an item based on the data points associated with the first item, the second machine learning model being updatable with the additional data points associated with the second time period;
comparing the first time to sell with the selling time;
comparing the second time to sell with the selling time; and
selecting the first machine learning model or the second machine learning model based on the comparing the first time to sell with the selling time and the comparing the second time to sell with the selling time.

15. The device of claim 14, wherein the instructions further cause the device to perform operations including:
obtaining data points associated with a second item;
providing the data points associated with the second item to the selected trained machine learning model; and
determining a time estimate associated with selling the second item with the selected trained machine learning model, the time estimate being based on the data points associated with the second item.

16. The device of claim 15, wherein the instructions further cause the device to perform operations including:
receiving an identification of the second item; and
retrieving the data points associated with the second item from a database based on the second item identification.

17. The device of claim 15, wherein the data points associated with the second item further comprise a feedback score associated with a seller of the second item and one or more of a price of the second item, a number of images associated with a listing of the second item, and a quantity of the second item.

18. The device of claim 14, wherein the instructions further cause the device to perform operations including:
obtaining data points associated with a third item during at least a portion of the second time period, the data points associated with the third item including a selling time associated with the third item where the selling time associated with the third item is different from the selling time associated with the first item; and
training the selected machine learning model with the data points associated with the third item, where further time estimates determined by the selected trained machine learning model differ from the time estimate associated with selling the second item based on the data points associated with the third item.

19. The device of claim 14, wherein the data points associated with the first item further comprise a feedback score associated with a seller of the first item and one or more of a price of the first item, a number of images associated with a listing of the first item, and a quantity of the first item.

20. The device of claim 14, wherein the instructions further cause the device to perform operations including assigning different weights to each of the data points associated with the first item, the weighted attributes being used to train each of the first machine learning model and the second machine learning model to predict the time estimate associated with selling the second item.
